(19) United States
(12) Patent Application Publication
(10) Pub. No.: US 2025/0086323 A1
(43) Pub. Date: Mar. 13, 2025

(54) Method for Checking the Integrity of a Neural Network

(71) Applicant: Siemens Aktiengesellschaft, Muenchen (DE)

(72) Inventors: Norbert BECK, Schwabach (DE); Hannes MUHR, Gallbrunn (AT); Herbert TAUCHER, Wien (AT); Christoph UNGER, Orth an der Donau (AT); Matthias WESS, Wien (AT)

(21) Appl. No.: 18/580,648

(22) PCT Filed: Jul. 20, 2022
(86) PCT No.: PCT/EP2022/070374

§ 371 Date: Jan. 19, 2024

(30) Foreign Application Priority Data
Jul. 22, 2021 (EP) 21187281.7

(51) Int. Cl. G06F 21/64

(52) U.S. Cl. CPC G06F 21/64

(57) ABSTRACT

A method for checking integrity of a neural network during execution, wherein the neural network has a defined structure and weighting factors determined in a training phase, where a systolic array is also used to implement the neural network, when the neural network is executed, a unique test value for each relevant processing element is determined via a series of weighting factors that occur serially in a relevant processing element and are processed by the relevant processing element, a set of unique test values are compared with corresponding reference values, the unique test values are compared with corresponding reference values for the relevant processing element, and if, during the comparison for at least one processing element, a deviation is identified between a unique test value determined during the execution and the corresponding reference value, then the neural network produced during execution is classified as untrusted.

### CROSS-REFERENCE TO RELATED APPLICATIONS

This is a U.S. national stage of application No. PCT/EP2022/070374 filed 20 Jul. 2022. Priority is claimed on European Application No. 21187281.7 filed 22 Jul. 2021, the content of which is incorporated herein by reference in its entirety.

### BACKGROUND OF THE INVENTION

### 1. Field of the Invention

The present invention generally relates to the field of neural networks and, more particularly, to a method for checking the integrity of a neural network, which is executed as an application or as a “inference” in a hardware unit or in a terminal, where the neural network is defined in this case by its structure and by weighting factors determined in a training phase, and where a “systolic array”, which has processing elements arranged in the form of a matrix, is also used for an implementation of the artificial neural network.

### 2. Description of the Related Art

With the advance of digitization and with the increase in process data associated therewith, neural networks are being employed nowadays for data processing for many complex problems. Neural networks can be used for data processing in such cases in practically all technical fields. Areas of application for neural networks lie, for example, in areas such as text, image and pattern recognition, making rapid decisions and/or in the area of classification tasks.

An artificial neural network principally represents an emulation of biological nervous systems with their associative method of operation. The outstanding attribute of the neural network particularly consists of its capability to learn, i.e., problems set such as text, image or pattern recognitions, and/or quick decision making, are solved based on trained knowledge. A neural network consists of a plurality of artificial neurons that, for example, simulate human brain cells. The neurons are grouped in the neural network into different layers and are characterized by a high degree of networking. At least one input layer for accepting raw data and an output layer, from which the conclusion or the result determined by the neural network is provided, are provided as layers, for example. One or more hidden layers can be provided between the layers, from which intermediate results can be determined and provided. Such a neural network is known, for example, from the publication EP 3 502 974 A1.

What is known as Deep Learning refers in such cases to a specific method of machine learning, which employs artificial neural networks with numerous “hidden” intermediate layers between the input layer and the output layer and thereby forms a comprehensive inner structure. In data processing or in learning, a data input from the visible input layer is processed and passed on as output to the next layer. This next layer for its part processes the information and likewise passes on the results to the second layer for further processing until the result is output into the last visible layer, the output layer.

In order to be able to be used for a predetermined task (for example, text, image or pattern recognition, voice synthesis, and/or decision making or classification task), the neural network must be trained in a training phase. During this training phase, the neural network is trained with the aid of, for example, predetermined training data and/or patterns to deliver an answer that is correct with regard to the task.

Here, starting from, for example, predeterminable or randomly selected values for a start weighting or for start weighting factors, which are attributed to the neurons, weighting or weighting factor and where necessary a bias value are modified for the respective neuron for each training cycle. The results of the neural network obtained in the respective training cycle are then, for example, compared with reference data/patterns, until a desired result quality is achieved. The weighting factors determined in this way are then stored, for example, in order to be included for the implementation of the respective task by the trained, neural network, i.e., the “inference”.

For executing a neural network trained in the training phase on a specific data pattern or an “inference”, with the weighting factors determined in the training phase and usually fixed, there is a broad palette of platforms. Depending on the requirements of the respective application, generic multicore CPUs and GPUs or integrated circuits, such as Field Programmable Gate Arrays (FPGAs) or User-Specific Integrated Circuits (known as ASICs), in particular specific neural network ASICs, can be used as the hardware platform, for example. FPGAs and/or specific neural network ASICs are in particular primarily used when it is a matter of tailor-made, real-time-capable and loss-optimized solutions, such as are usually required for example in areas such as automotive, mobility and/or automation.

Frequently, for an efficient implementation of neural networks, in particular when deep learning is used, “systolic arrays” or a “systolic arrangement” are employed. A systolic array is a homogeneous network of coupled cells, nodes or processing elements. The processing elements in this case are arranged in the form of a matrix (for example, as a two-dimensional matrix) and configured for a specific application. Each processing element independently computes a part result based on data received from its preceding neighboring cells, stores this data and conveys it onwards downstream, where the forwarding is initiated, for example, by the arrival of new data in the processing unit concerned. That is, a data stream is, for example, clocked as a type of wave through the systolic array. When a neural network or the respective layers of the neural network are processed by the systolic array, a central processor unit ensures, for example, inter alia that, for example, along with a set of input data, the weighting factors of the neural network are conveyed at the correct point in time from a main memory to the respective processing element. The weighting factors of the neural network in this case determine the influence of the respective processing element on the part result of the respective processing element. An implementation of a neural network with the aid of a systolic array is known, for example, from U.S. Pat. No. 10,817,260 B1.

When trained, neural networks, i.e., “inferences”, are used, particularly in areas such as automotive, mobility and/or automation, it is most important to guarantee reliability, robustness and safety of the respective systems. Neural networks are defined in particular by the arrangement of the neurons and by their connections to one another, i.e., by their structure or topology. Typical structures are, for example, single-layer or multilayer feed-forward networks or recurrent networks. Furthermore neural networks are also defined by their trained behavior, i.e., by the weighting factors that have been determined in the training phase. A change to one of the two, i.e., of the structure and/or of the trained behavior, would lead in an application of a trained, neural network (i.e., of an inference) in a hardware unit or in a terminal to erroneous, wrong and thereby untrustworthy results.

One security threat for the correct processing of a neural network, which leads to wrong and untrustworthy results, is represented, for example, by an intentional modification of the trained weighting factors, in a memory unit that makes these factors available for the processing elements of the systolic array, for example. Furthermore, the weighting factors can be modified unintentionally or influenced in the memory unit, for example, by concurrent processes that are operating on the same memory. Also what is known as bit flipping, which can be caused for example by physical influences, such as radiation, and/or power supply, can represent a safety threat for correct processing of the neural network. The weight factors in the memory can be changed or influenced, for example, by bit flipping. Furthermore the weight factors can also be modified on the way from the main memory into the systolic array or on the way through the systolic array. An erroneous or wrong result of a neural network can above all in safety-relevant areas lead to critical situations. Therefore, it is important to check the integrity of neural networks, above all the integrity of the structure (network graph) and the integrity of the weight factors of the neural network, even during ongoing operation in a terminal, particularly for terminals in use in safety-relevant areas, or during execution on a hardware unit.

### SUMMARY OF THE INVENTION

In view of the foregoing, it is therefore an object of the invention to provide a method for checking the integrity of a neural network, through which, during execution on a hardware unit or in a terminal, changes to the structure and/or to the weight factors of the neural network can be detected in a simple way and without great effort.

This and other objects and advantages are achieved in accordance with the invention by a method for checking the integrity of a neural network during its execution in a hardware unit or in a terminal as an application or inference. The neural network is defined in this case by its structure, i.e., arrangement and connection of its neurons, and also by weighting factors determined in a training phase, which determine a behavior of the neural network. For the implementation of the neural network, a “systolic array” is employed, which has processing elements arranged in the form of a matrix. When the neural network is being executed in the hardware unit, in each processing element of the systolic array, via a sequence of weighting factors, which arrive in series in the respective processing element and are processed by the respective processing element, by accumulation, such as by application of a hashing algorithm, a unique check value is determined for the respective processing element. After execution of the neural network a set of unique check values is then available. These unique check values are compared with corresponding reference values. Here, the unique check value determined for the respective processing element is compared with a corresponding reference value for the respective processing element. If, during the comparison, a deviation between the unique check value determined in each case during the execution and the corresponding reference value is established for at least one processing element, then a result of the neural network created during the execution is classified as unsafe or as untrustworthy.

The main aspect of the present invention consists in the integrity of a neural network, while it is being executed as an “inference” or as an application in a hardware unit or in a terminal, being safeguarded via a systolic array in a simple way and with a relatively low additional hardware outlay. Through the method, ideally both the integrity of the trained behavior of the neural network, i.e., of the weighting factors, and also the order of the weighting factors of the neural network, are checked for integrity, because the weighting factors are accumulated in the order in the respective processing units of the systolic array in which they are made available to the respective processing units. Through the comparison of the respective check value determined in the respective processing unit with a corresponding reference value for the respective processing unit wrong or erroneous results of the neural network are very easy to recognize. The method thus makes it possible in a simple way to recognize threats to safety by deliberate modification (security threats) or by unintentional modification (for example, bit flipping, modification by concurrent processes in the memory or during transmission from the memory into the systolic array, safety threats) of the weighting factors and to set corresponding measures depending on application and use of the neural network (for example, error or alarm message, and/or aborting the application)

In an expedient embodiment of the invention, checking units are provided in the processing elements of the systolic array, which are formed as additional hardware components in the processing elements and by which the respective weighting factors for the check values are accumulated. The additional hardware outlay for the determination of the check values in the processing elements of the systolic array is thus relatively small by comparison with the outlay for the systolic array for the processing of the neural network. The checking unit in the processing elements of the systolic array can already be planned in in a design phase of the hardware (for example, FPGA, ASIC) for the execution of the neural network for example.

It is advantageous for a cyclic redundancy check (CRC) to be used for determining the check value from the sequence of weighting factors processed by the respective processing element. A cyclic redundancy check (CRC) is a method with which in a simple way a check value is determined, for data, for example, in order to detect errors in the data, which can occur, for example, during the transmission and/or storage. In the processing elements of the systolic array, the cyclic redundancy check can be applied very simply to the weighting factors of the neural network, which are conveyed in a predetermined order from a memory unit to the processing units.

When a cyclic redundancy check is used, ideally the corresponding reference value of the respective processing element can be inserted as the final or last weighting factor into the sequence of weighting factors of the respective processing element. That is, the respective reference value is part of the respective weighting factor set that is processed by a processing element. The respective reference value is inserted as a last, additional weighting factor for the check value determined at the end of the processing. It is then very easy to check whether the resulting sum produces a predetermined value, usually zero, whereby modifications of the weighting factors and/or changes to the sequence of the weighting factors can be recognized very easily.

Furthermore, it is also useful if a hashing algorithm is employed for determining the check value from the sequence of weighting factors processed by the respective processing element. Through the use of a hashing algorithm, in order to accumulate the sequence of the weighting factors in the respective processing element to a unique check value, the safety of the method is increased for recognizing modifications and changes. A hashing algorithm represents a mapping of a large set of input data, such as the weighting factors, to a smaller target set, such as the check value of the respective processing element. Here, the hashing algorithm delivers values for the input data, such that different input data also lead to different output values. This means that an output value generated via a hashing algorithm is ideally unique and collision-free.

Depending on the respective use of the array, the weighting factors are only shifted from one edge of the matrix-shaped arrangement of the processing elements across the systolic array. Consequently, it is recommended that a check value only be determined from those processing elements of the systolic array by which input interfaces for the weighting factors into the systolic array are formed. As an alternative, the determination of the check value can be reduced to those processing elements of the systolic array from which output interfaces for the weighting factors are formed in the systolic array. Thus, the outlay for checking the integrity of the neural network can be further reduced in a simple way.

It is also advantageous to form a check signature from the check values of the processing elements by cell and/or column-wise accumulation. In this way, for example, not all check values generated by the processing elements have to be shifted out of the systolic array but, for example, check signatures for the cells and/or columns of the matrix-shaped arrangement of the processing elements or a check signature for the entire arrangement of the processing elements of the systolic array is determined, for example. These cell and/or column check signatures or the single check signature for the entire array are then compared with the corresponding reference values in each case.

Expediently, there is provision for the reference values for the processing elements to be determined via analytical derivation or by simulation in a design phase of the neural network or with the aid of at least one initial execution of the neural network. In analytical derivation, the reference values for the processing elements, cells or columns of processing elements or for the check signature of the entire array are calculated via mathematical methods. As an alternative, the reference values can also be defined in a simple way in the design phase of the neural network via simulation, where for the simulation the same weighting factors are used for the neural network as for the ongoing operation or the execution in the terminal or in the hardware unit. A further possibility for determining the reference values is offered by at least one initial pass of the neural network in a trustworthy environment under trustworthy conditions, for example, directly after an implementation in the terminal or in the hardware unit for the ongoing operation. In this at least one initial pass, the check values are determined in the processing elements under largely real conditions, which then serve as reference values. It is useful in such cases for a number of “initial” passes to be performed and for the reference values to be defined for the integrity checking, for example, as an average of the check values determined in the passes.

In a preferred embodiment of the invention, the reference values for the processing units are stored in a memory unit of the hardware unit, upon which the neural network is executed.

The reference values are thus available rapidly and without any great effort for the comparison with the check values determined during the execution of the neural network. The reference values can, for example, be stored in the same memory unit as the weighting factors of the neural network, provided the memory area for the reference values is trustworthy.

In a further embodiment of the invention, a Field Programmable Array (FPGA) or an Application-Specific Integrated Circuit (ASIC) is used as the hardware platform for the implementation of the neural network.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be explained below by way of an example with the aid of the enclosed figures, in which:

FIG. 1 shows an exemplary schematic diagram of an architecture for implementing the inventive method for checking the integrity of a neural network; and

FIG. 2 shows an exemplary execution sequence of the inventive method for checking the integrity of a neural network during execution in a terminal.

### DETAILED DESCRIPTION OF THE EXEMPLARY EMBODIMENTS

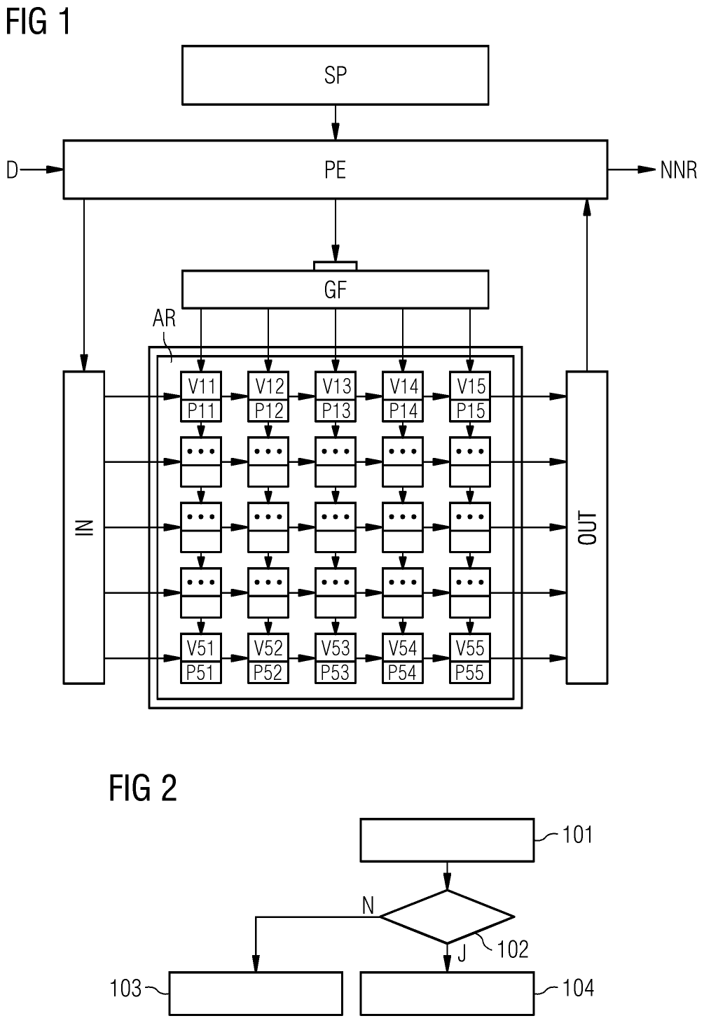

FIG. 1 shows by way of example and schematically an architecture of a hardware unit, which can be employed in a terminal for execution or for layer-by-layer processing of a neural network. Furthermore, the architecture shown by way of example in FIG. 1 is configured for implementing the inventive method for checking the integrity of a neural network during ongoing operation. In an architecture of this type, a Field Programmable Array (FPGA) or an Application-Specific Integrated Circuit (ASIC), in particular specific ASICs for realizing neural networks, can be used, for example, as a hardware platform for the implementation of the neural network.

The example of the hardware architecture has at least one central processing unit PE, which receives input data IN (for example, image data, and/or patterns) via a data input D from a camera, etc., for example. Furthermore, the hardware architecture has a memory unit SP, in which, for example, the weighting factors GF determined in a training phase are stored. These weighting factors GF are made available as an inference by the central processing unit PE from the memory unit SP to a systolic array AR during the execution of the neural network. Likewise, the input data IN, to which the weighting factors are to be applied, are conveyed from the central processing unit PE to the systolic array.

The systolic array has processing elements V11, . . . , V55 arranged in the form of a matrix, which propagate the input data IN and the weighting factors locally. The central processing unit PE, as well as other tasks, ensures that during the execution of the neural network or the processing of the layers of the neural network, the weighting factors GF are conveyed at the right point in time from the memory unit SP to the respective processing elements V11, . . . , V55. In this case, the processing elements V11, V12, V13, V14, V15 of the systolic array, for example, form input interfaces for the weighting factors GF within the systolic array, at which the weighting factors GF are accepted into the systolic array or from which the weighting factors are shifted across the systolic array AR. The processing elements V51, V52, V53, V54, V55 form output interfaces for the weighting factors GF, for example.

The input data IN can be conveyed to the processing elements V11 to V51, for example, which form a first column of the matrix arrangement, for example. Output data or results OUT of the systolic array are conveyed via the processing elements V15 to V55, which form a last column of the matrix arrangement, for example, to the central processing unit PE. From the central processing unit PE, the output data or the results OUT of the systolic array are then, where necessary, grouped together into a result NNR of the neural network and made available via a data output.

Furthermore, the processing elements V11, . . . , V55 of the systolic array AR have check units P11, . . . , P55. These check units P11, . . . , P55 are formed as additional hardware components in the respective processing elements V11, . . . , V55. The check units P11, . . . , P55 accumulate those weighting factors GF, which are processed by the respective processing elements V11, . . . , V55, by application of a hashing algorithm to unique check values. That is, a unique check value for the first processing element V11 is formed, for example, by a first checking unit P11 in a first processing element V11 of the systolic array during the execution of the neural network for each layer, for example, because a series of the weighting factors GF arriving serially in the first processing element V11 are accumulated by the checking unit P11. Similarly, a unique check value is determined for the second processing element V12 by a second checking unit P12, which is provided in a second processing element V12, in which the weighting factors GF arriving serially in the second processing element V12 are accumulated. The unique check values for the further processing elements V13, . . . , V55 are likewise determined in this way by the respective checking units P13, . . . , P55 of the further processing elements V13, . . . , V55.

FIG. 2 shows an exemplary execution sequence of the method for checking the integrity of a neural network while the method is being executed in a terminal or in a hardware unit as an inference. Here, an architecture, which is shown schematically and by way of example in FIG. 1, is used as a hardware platform for the implementation of the neural network, for example.

In a determination step 101 of the method, which is executed by the systolic array AR during the execution of the neural network or during the processing of the layers of the neural network, a unique check value in each processing element V11, . . . , V55 of the systolic array AR is determined. For this purpose, a series of those weighting factors GF, which arrive serially during the execution of the neural network in the respective processing element V11, . . . , V55, for example, accumulated by the check unit P11, . . . , P55 provided in the respective processing element V11, . . . , V55, are accumulated. The respective weighting factors GF are conveyed in this case from the central processing unit PE (at the correct point in time and in the sequence determined for example during the training phase) from the memory unit SP to the respective processing elements V11, . . . , V55.

The determination of the respective, unique check value for the respective processing element V11, . . . , V55 from the series of weighting factors GF processed by the respective processing element V11, . . . , V55 can be performed, for example, via a cyclic redundancy check method or a cyclic redundancy check (CRC). Furthermore, a hashing algorithm can be used for the determination of the respective, unique check value, through which the weighting factors GF processed in the respective processing element V11, . . . , V55 are accumulated to a unique and collision-free check value for the respective processing element V11, . . . , V55 in determination step 101.

Instead of determining a unique check value in each processing element V11, . . . , V55 of the systolic array AR in the determination step 101, a calculation of check values can be restricted, for example, to those processing elements V11 to V15 that, for example, form input interfaces for the weighting factors in the systolic array AR. As an alternative, for example, the check values can also only be calculated in those processing elements V51 to V55 of the systolic array AR by which output interfaces are formed for the weighting factors GF in the systolic array AR. A further simplification, for example, consists of a check signature being calculated at the end of the determination step 101 out of the respective check values determined. Here, the check values of the respective processing elements V11, . . . , V55 are accumulated cell-by-cell and/or column-by-column and all check values determined do not have to be displaced from the systolic array at the end of the determination step 101.

After determination of the unique check values for all processing units V11, . . . , V55, for the input interface processing elements V11 to V15 or for the output interface processing elements V51 to V55 or the calculation of a check signature from the unique check values in determination step 101, a unique set of check values or a unique check signature is available. The check values or the check signature formed from them are then compared, in comparison step 102 with corresponding reference values. That is, if a unique check value, for example, has been generated by each processing element V11, . . . , V55 or by the associated check unit P11, . . . , P55 in determination step 101, in comparison step 102 each of these check values is compared with a corresponding reference value for the respective processing element V11, . . . , V55. If, in determination step 101, check values are only determined for the input interface processing elements V11 to V15 or for the output interface processing elements V51 to V55, then in comparison step 102 only corresponding reference values for these processing elements V11 to V15 to V51 to V55 are included and compared with the respective check values. If, for example, in the determination step 101 a check signature is determined for the neural network from the check values, in comparison step 102, this check signature is thus compared with a reference signature.

The reference values, which are included in the comparison step 102, can be stored in a memory unit of the hardware unit, for example. The memory unit SP in which the weighting factors GF for the trained, neural network are also stored can be used as the memory unit, for example.

Furthermore, for example, a cyclic redundancy method or a cyclic redundancy check for calculating the unique check values in the processing elements V11, . . . , V55 or in the associated check units P11, . . . , P55 of the corresponding reference value can be inserted as a final weighting factor in the sequence of the weighting factors GF of the respective processing element V11, . . . , V55. The respective reference value is thus a part of the weighting factor set and is then accumulated at the end of the determination step 101 to the respective check value (i.e., the accumulated weighting factors of the respective processing element V11, . . . , V55). Then, in comparison step 102 it no longer has to be checked, for example, whether the resulting sum is produced from check value (or the accumulated weighting factors of the respective processing element V11, . . . , V55) and reference value, for example, produces a value equal to zero or not equal to zero.

The reference values that are compared with the respective check values in comparison step 102 can be determined, for example, via analytical derivation or by simulation in a design phase of the neural network or with the aid of at least one initial execution of the neural network. In the analytical derivation the reference values are calculated for the processing elements V11, . . . , V55, for the input interface or output interface processing elements V11 to V15 or V51 or V55 or for the check signature of the entire systolic array AR via mathematical methods. As an alternative, the reference values can also be defined, for example, during the design phase of the neural network by means of simulation, where the same weighting factors GF as for the ongoing operation or the execution of the neural network in the terminal or in the hardware unit must be used for the simulation. The reference values or the reference signature can also be determined via an initial pass of the neural network in a trustworthy environment or under trustworthy conditions, for example, immediately after implementation in the terminal or in the hardware unit. Here, for example, a number of “initial” passes can be performed and the reference values or the reference signature for the integrity checking defined, for example, as an average of the values defined in the passes. If it is established during the comparison step 102 that the unique check value determined for this processing element V11, . . . , V55 deviates from the corresponding reference value for at least one processing element V11, . . . , V55 then, in a first evaluation step 103, the result of the neural network is classified as untrustworthy. That is, if a check value determined in the check unit P11, . . . , P55 of a processing element V11, . . . , V55 does not match the corresponding reference value, then it can be recognized in the first evaluation step 103 that, for example, a change in the weighting factors GF (for example, value and/or sequence) is present. This also applies if, for example, a check signature has been determined from the determined check values for the neural network and this does not match the reference signature.

If, for example, when a cyclic redundancy method or a cyclic redundancy check is used, the reference value is accumulated as a final weighting factor for the respective check value (i.e., the accumulated weighting factors of the respective processing element V11, . . . , V55), and it is established in comparison step 102 for at least one processing element V11, . . . , V55 that the resulting sum is not equal to the value zero, then the result NNR of the neural network is likewise classified in the first evaluation step 103 as untrustworthy. Then, for a classification of the result NNR as untrustworthy, depending on the application of the neural network, corresponding measures can be set, such as discarding the results, output of a corresponding message or signaling an alarm, and/or stopping the execution, for example.

If no deviation between the unique check values of the processing units V11, . . . , V55 or the check signature and the corresponding reference values or the reference signature is established in comparison step 102, then in a second evaluation step 104 the result NNR of the neural network is classified as trustworthy. A classification of the result NNR of the neural network as trustworthy in the second evaluation step 104 also occurs if, for example, when a cyclic redundancy method or a cyclic redundancy check is used, the resulting sums of respective check value and corresponding reference value, the value of zero is produced as a final weighting factor for each processing element V11, . . . , V55 for which the check value is determined, for example. A result NNR of the neural network classified as trustworthy can then be further processed accordingly, depending on application, because the integrity of the neural network in the terminal is ensured. Thus, through the method, a certain reliability and robustness (safety) and a certain protection against intentional changes and falsifications of the neural network in the terminal can be achieved.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-10. (canceled)

11. A method for checking an integrity of a neural network during execution in a hardware unit, the neural network having a defined structure and weighting factors determined during a training phase, and a systolic array having processing elements form as a matrix is employed for an implementation of the neural network, the method comprising:
determining a unique check value by application of a hashing algorithm in each processing element of the systolic array, via a sequence of these weighting factors arriving serially, which are processed by a respective processing element when the neural network is executed;
comparing the unique check value determined for the respective processing element with a corresponding reference value for the respective processing element after the execution of the neural network; and
classifying a result of the neural network as untrustworthy if, for at least one processing element, each unique check value determined during the execution deviates from the corresponding reference value.

12. The method as claimed in claim 11, wherein check units are provided in the processing elements of the systolic array, which are formed as additional hardware components in the processing elements and by which the respective weighting factors are accumulated to unique check values.

13. The method as claimed in claim 12, wherein a cyclic redundancy checking method is utilized to determine the unique check value from the sequence of weighting factors processed by the respective processing element.

14. The method as claimed in claim 12, wherein a cyclic redundancy checking method is utilized to determine the unique check value from the sequence of weighting factors processed by the respective processing element.

15. The method as claimed in claim 13, wherein the reference value of the respective processing element is inserted as a final weighting factor into the sequence of weighting factors of the respective processing element.

16. The method as claimed in claim 11, wherein the unique check value is only determined from those processing elements of the systolic array by which input interfaces are formed for the weighting factors in the systolic array.

17. The method as claimed in claim 11, wherein the unique check value is only determined from those processing elements of the systolic array by which output interfaces are formed for the weighting factors in the systolic array.

18. The method as claimed in claim 11, wherein a check signature is formed from the check values of the processing elements by at least one of cell-by-cell and column-by-column accumulation.

19. The method as claimed in claim 11, wherein the reference values for the processing elements are determined via one of (i) analytical derivation, (ii) simulation in a design phase of the neural network and (iii) aided by at least one initial execution of the neural network.

20. The method as claimed in claim 11, wherein the reference values for the processing units are stored in a memory unit of the hardware unit upon which the neural network is executed.

21. The method as claimed in claim 11, wherein a Field Programmable Array or an Application-Specific Integrated Circuit is utilized as a hardware platform for the implementation of the neural network.

22. The method as claimed in claim 11, wherein the hardware unit comprises a terminal.
